(19) United States
(12) Patent Application Publication
(10) Pub. No.: US 2011/0246596 A1
(43) Pub. Date: Oct. 6, 2011

(54) LOAD-AWARE METHOD OF OPTIMIZING COMMAND EXECUTION IN A CLOUD ENVIRONMENT

(75) Inventors: Bao Hua Cao, Beijing (CN); Ying Chen, Beijing (CN); Le He, Beijing (CN); Xing Jin, Beijing (CN); Qing Bo Wang, Beijing (CN)

(73) Assignee: INTERNATIONAL BUSINESS MACHINES CORPORATION, Armonk, NY (US)

(21) Appl. No.: 13/076,381

(22) Filed: Mar. 30, 2011

(30) Foreign Application Priority Data
Mar. 31, 2010 (CN) 201010139124.X

(51) Int. Cl. G06F 15/16

(52) U.S. Cl. 709/208

(57) ABSTRACT

A command controlling method and a command controller for controlling execution of a plurality of commands on a remote machine are provided. The command controlling method includes determining a priority of each of the plurality of commands according to predetermined properties of the command, determining command package maximum total execution time according to a current workload of the remote machine, packaging the plurality of commands into one or more command packages in a descending order of priority according to the maximum total execution time, and sending the one or more command packages to the remote machine. By means of the command controlling method and the command controller, execution of commands in a cloud environment may be optimized to improve performance of the cloud environment.

### BACKGROUND

The present invention relates to a command controlling method and a command controller, and in particular, to a command controlling method and a command controller for controlling execution of a plurality of commands on a remote machine in a cloud environment.

At present, cloud computing has become a research hotspot. In order to perform the cloud computing effectively, it is necessary to continuously build and update a cloud environment. The cloud environment consists of a number of remote machines. The remote machines described herein include remote physical machines and remote virtual machines, unless otherwise stated. A core method for building and updating the cloud environment is to execute commands remotely on the remote machines, so as to perform corresponding activities on the remote machines or acquire dynamic information of the remote machines, in which the dynamic information of the remote physical machines includes server basic information of the remote physical machines (servers), information concerning CPUs and memories of the remote physical machines, and so on, and the dynamic information of the remote virtual machines includes server basic information of the remote virtual machines (servers), information concerning virtual CPUs and virtual memories of the remote virtual machines, configuration information of the remote virtual machines, and so on.

From another viewpoint, executing commands on the remote machines is also an essential factor for generating a workload of the cloud environment. Particularly, executing commands on the remote machines consumes memory space and computing power of CPUs of the remote machines, thereby generating the workload. Moreover, since different commands are executed at different times, the workloads generated by executing these commands are also different.

It is often necessary to remotely execute a number of commands when building and updating the cloud environment, wherein these commands appear randomly, and many of them tend to be executed in real time. If these commands are executed in real time in the cloud environment without control, more computing resources will be consumed, and the workload of the cloud environment becomes unstable and difficult to be predicted and managed, so that performance of the cloud environment is degraded. Further, in order to execute a command in real time, it is necessary to establish a direct network connection with a remote machine. Thus, a number of such network connections will be established when there are a number of commands to be executed in real time. At this time, once a network connection fails, a corresponding command cannot be executed, which results in a task failure. Moreover, a fundamental command line interface on a remote machine is invoked without control due to randomness of appearance of the commands, such that the risk of failed command execution increases. On the other hand, for commands which do not have to be executed in real time, they are processed by using a buffering mechanism, and execution results thereof are temporally stored; the results temporally stored will become inaccurate as time lapses if no corresponding updating mechanism is provided.

Therefore, there is a need for a command controlling method and a command controller which are capable of optimizing execution of a command in a cloud environment (remote machine) so as to improve performance of the cloud environment.

### BRIEF SUMMARY

The present invention is made in view of the above problems. An embodiment of the present invention provides a command controlling method and a command controller capable of dynamically scheduling commands to be executed on a remote machine according to a workload of a cloud environment (the remote machine), so as to optimize execution of the commands and improve performance of the cloud environment.

According to an embodiment of the present invention, there is provided a command controlling method for controlling execution of a plurality of commands on a remote machine, comprising: determining a priority of each of the plurality of commands according to predetermined properties of the command; determining command package maximum total execution time according to a current workload of the remote machine; packaging the plurality of commands into one or more command packages in a descending order of priority according to the maximum total execution time, respectively; and sending the one or more command packages to the remote machine.

According to another embodiment of the present invention, there is provided a command controller for controlling execution of a plurality of commands on a remote machine, comprising: a load detector for detecting a current workload of the remote machine; and a command analyzer for determining a priority of each of the plurality of commands according to predetermined properties of the command, determining command package maximum total execution time according to the detected current workload of the remote machine, packaging the plurality of commands into one or more command packages in a descending order of priority according to the maximum total execution time, respectively, and sending the one or more command packages to the remote machine.

The command controlling method and the command controller according to the above embodiments of the present invention package determines commands to be executed on a remote machine according to predetermined properties of the commands and a workload of a cloud environment, so as to perform effective dynamic scheduling of execution of the commands and improve performance of the cloud environment.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a flow chart showing a command controlling method according to an embodiment of the present invention;

FIG. 2 is a flow chart showing an exemplary implementation of the command controlling method according to the embodiment of the present invention;

FIG. 3 is a flow chart for explaining step S205 in FIG. 2;

FIG. 4A is a function diagram for schematically showing a relationship between first execution time and CPU usage of a remote machine;

FIG. 4B is a function diagram for schematically showing a relationship between second execution time and available memory of a remote machine;

FIG. 4C is a function diagram for schematically showing a relationship between predicted transmission time and network load;

FIG. 5 is a function diagram for schematically showing a relationship between command package maximum total execution time and workload of a remote machine;

FIG. 6 is a flow chart for explaining step S208 in FIG. 2;

FIG. 7 is another flow chart for explaining step S208 in FIG. 2;

FIG. 8A is a diagram for schematically showing an example of commands sorted in a descending order of priority;

FIG. 8B is a diagram for schematically showing a result of packaging the commands shown in FIG. 8A; and

FIG. 9 is a block diagram for showing a command controller according to an embodiment of the present invention.

### DETAILED DESCRIPTION

A command controlling method and a command controller according to an embodiment of the present invention will be described below with reference to the accompanying drawings.

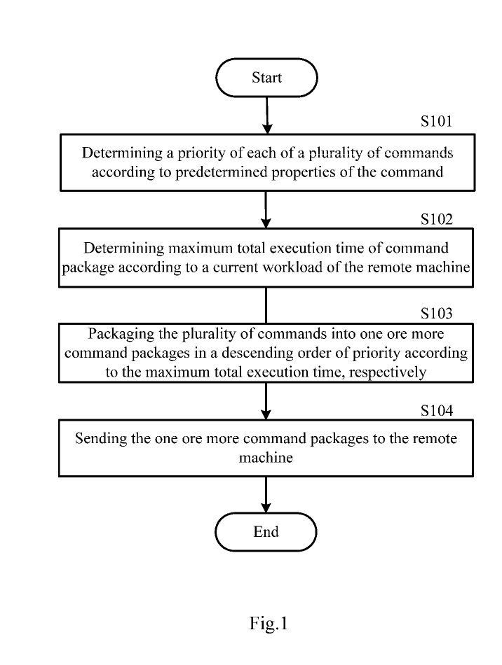

First, the command controlling method according to an embodiment of the present invention will be described briefly with reference to FIG. 1. The command controlling method can be executed by a command controller, wherein the command controller is located between a management platform for building and updating a cloud environment and sending one or more commands and a remote machine in the cloud environment for executing the commands send by the management platform, or belongs to a part of the management platform (in this case, the command control method can be considered as being executed by the management platform).

As shown in FIG. 1, at step S101, a priority of each of a plurality of commands is determined according to predetermined properties of the command. As described below, the predetermined properties may include one or more of predicted execution time, predicted transmission time, execution result live time, and a command frequency of the command. The priority is used to determine an order in which the command is packaged, and thereby determine an order in which the command is sent to a remote machine.

Next, at step S102, a command package maximum total execution time is determined according to a current workload of the remote machine. Then, at step S103, the plurality of commands are respectively packaged into one or more command packages in a descending order of priority according to the maximum total execution time.

Subsequently, at step S104, the one or more command packages are sent to the remote machine for execution therein.

In practice, it is often necessary to execute a number of commands when building and updating a cloud environment. Different commands have different requirements for real-time execution; that is, some commands prefer to be executed in real time, and some other commands may be not executed in real time. In view of this, in the following exemplary implementation of the command controlling method according to the embodiment of the present invention, the commands sent by the management platform are classified into two types: the commands to be executed in real time and the commands not to be executed in real time. For the commands to be executed in real time, a scheduling process described below is not performed, and these commands are sent directly to the remote machine for execution. For the commands not to be executed in real time, the process described below is performed so that execution of these commands is effectively scheduled.

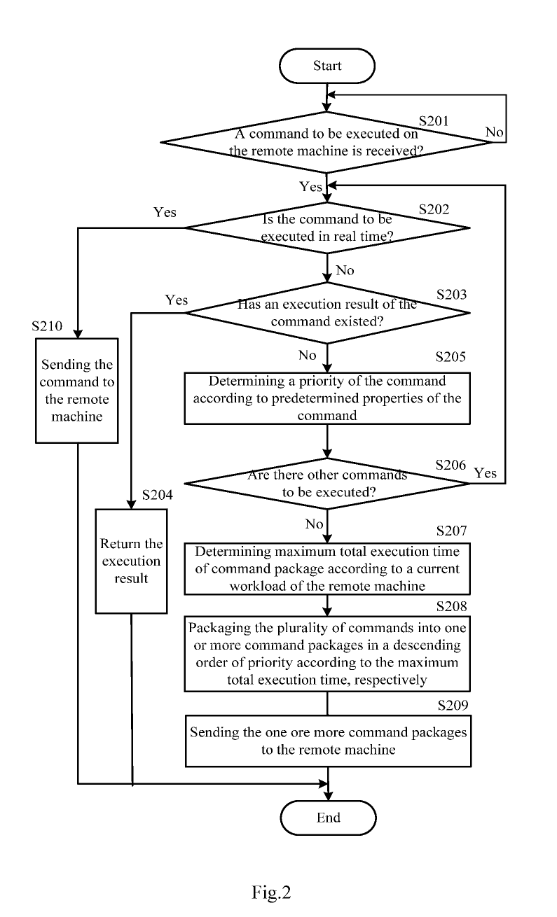

The exemplary implementation of the command controlling method according to the embodiment of the present invention will be described below with reference to FIG. 2.

As shown in FIG. 2, at step S201, it is determined whether a command to be executed on the remote machine is received from the management platform. If the command is not received, the process returns to step S201. On the contrary, if the command is received, it is determined whether the command is to be executed in real time. Whether the command is to be executed in real time may be designated by the management platform sending the command in advance, or determined according to natures (for example, a function to be realized by it, an executor of the command, or the like) of the command to be executed or other factors. It is to be noted that step S201 can be omitted if the command controlling method is executed by the management platform.

If it is determined at step S202 that the command is not to be executed in real time, it is determined at step S203 whether an execution result of the command has existed.

During the process of building and updating the cloud environment, a same command is often be executed for many times, and when the remote machine executes a command, it sends the execution result of the command back to the command controller such that the execution result is temporarily stored in the command controller and then returned to the management platform. Since there is a period of time between the temporary storage and the return of the execution result, in order to avoid a too old execution result from being returned to the management platform, an expire time ET is set for the command corresponding to each execution result to indicate when the execution result of the command expires. If a same command was just executed before a command is executed, and the expire time of the execution result of the command does not arrive, the execution result temporarily stored in the command controller may be returned to the management platform without the need of executing the command. On the contrary, if no same command has been executed, or if the same command has been executed but the execution result thereof has expired, it is considered that the execution result of the command does not exist and the command needs to be executed.

Therefore, returning to FIG. 2, if it is determined at step S203 that the execution result of the command exists, the execution result is returned to the management platform at step S204 without executing the command, and then the process ends. On the contrary, if the execution result of the command does not exist, a priority of the command is determined according to predetermined properties of the command, and a method for determining the priority will be described in detail later.

Subsequently, it is determined at step S206 whether there are other commands to be executed, that is, whether other commands to be executed are received from the management platform. If there are other commands to be executed, the process returns to step S202, and steps S202-S206 are executed in the above manner. On the contrary, if there are not other commands to be executed, command package maximum total execution time is determined according to a current workload of the remote machine at step S207, and the plurality of commands are respectively packaged into one or more command packages in a descending order of priority at step S208. Methods for determining the maximum total execution time and packaging the plurality of commands will be described in detail later.

Next, at step S209, the one or more command packages are sent to the remote machine for execution therein. Here, the one or more command packages may be sent in the descending order of priorities of the commands in the command packages or in other orders. Then, the process ends.

On the other hand, if it is determined at step S202 that the command is to be executed in real time, the command is sent at step S210 to the remote machine for execution, and then the process ends.

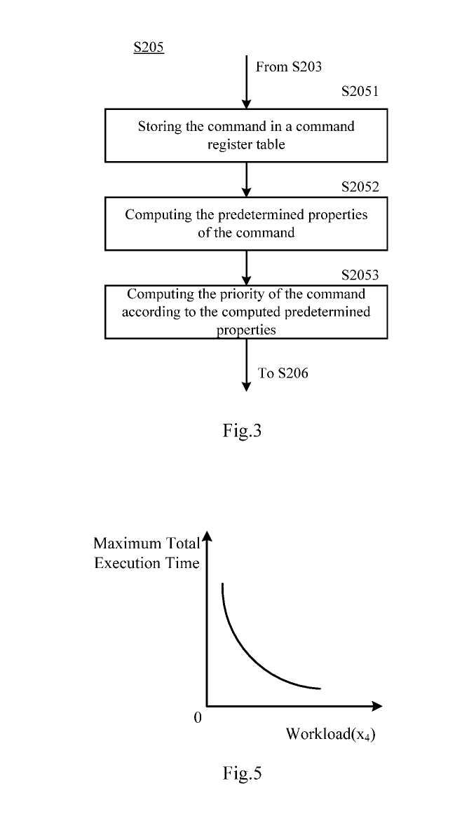

The process for determining the priority of the command in step S205 shown in FIG. 2 will be described in detail below with reference to FIG. 3.

As shown in FIG. 3, at step S2051, the command is stored in a command register table which may be stored in, for example, a storage of the command controller.

An example of the command register table is given in the following Table 1. As shown in Table 1, the command register table includes a plurality of entries (lines), each of which corresponds to a command and includes items of “index”, “name”, “latest request time”, “live time”, “command frequency”, “predicted transmission time”, “predicted execution time” and “result pointer”. The “index” and the “name” are used to identify the command stored in the command register table. The “latest request time” refers to the time when the command (in other words, a command the same as the command) is last received. The predicted execution time PET refers to the predicted time needed for executing the command on the remote machine, which depends on complexity of the command. The predicted transmission time PTT refers to the predicted time needed for transmitting the command from the command controller to the remote machine via a network, which depends on a network transmission delay. The live time LT refers to the time during which the execution result of the command (in other words, a command the same as the command) is effective. The command frequency CF refers to a frequency at which the command is received, in other words, a number of times that a command the same as the command is received in unit time. The “result pointer” indicates a storage position of the execution result, which is obtained by executing the command by the remote machine, in the command controller. As described hereinafter, the execution result may be stored in a command result storage of the command controller; at this time, the “result pointer” indicates the storage position of the execution result in the command result storage. When the command is stored in the command register table, the name of the command is extracted from the command, and the latest request time of the command recorded automatically by the command controller is written into an entry corresponding to the command.

TABLE 1
Command register table

| | | Latest | Live | Command | Predicted | Predicted | |
|---|---|---|---|---|---|---|---|
| | | request | time | frequency | transmission | execution | Result |
| Index | Name | time | (second) | (times/second) | time (ms) | time (ms) | pointer |
| 1 | foobar | 2010.3.1 | 1800 | 10 | 100 | 20 | 24 |
| | | 13:45 | | | | | |
| . . . | . . . | . . . | . . . | . . . | . . . | . . . | . . . |

Next, at step S2052, the predetermined properties of the command (referred to as the current command hereinafter for convenience of description) are computed. The predetermined properties include the predicted execution time PET, the predicted transmission time PTT, the live time LT of the execution result and the command frequency CF described above.

The method for computing the four properties will be described below.

It is recognized by the inventor that many physical quantities which are unstable but have tendency follow or approximately follow an exponent distribution, and the exponent distribution is often used to approximate a distribution of “life time”, such as life time of an electronic component, a conversation duration of a telephone call, and service time of a random service system, etc.; since the transmission time of the command is similar to the conversation duration of the telephone call, and the execution time of the command is similar to the service time of the random service system, the execution time and the transmission time of the command may be likewise predicted by using exponent functions. Moreover, experientially, the exponent function can reflect the tendency of the execution time of the command well: when a CPU is idle, a CPU usage is low, and the execution time of the command is short; as the CPU usage increases, the CPU becomes busy, and the execution time of the command becomes long. Likewise, the exponent function can also reflect the tendency of the transmission time of the command well: the smaller a load of a network, the more idle the network, and the shorter the transmission time of the command; the larger the load of the network, the busier the network, and the longer the transmission time of the command. Therefore, in the embodiment of the present invention, it is preferable to compute the predicted execution time and the predicted transmission time of the command by using the exponent functions, although other functions, such as pan-normal distribution functions, may be used.

(1) Predicted Execution Time Pet

As described above, the predicted execution time PET of the current command is highly associated with the CPU usage and the available memory of the remote machine executing the command, and is a sum of an execution time t_{execution1} (referred to as first execution time) associated with the CPU usage and an execution time t_{execution2} (referred to as second execution time) associated with the available memory as follows:

PET=t_{execution1}+t_{execution2} (1)

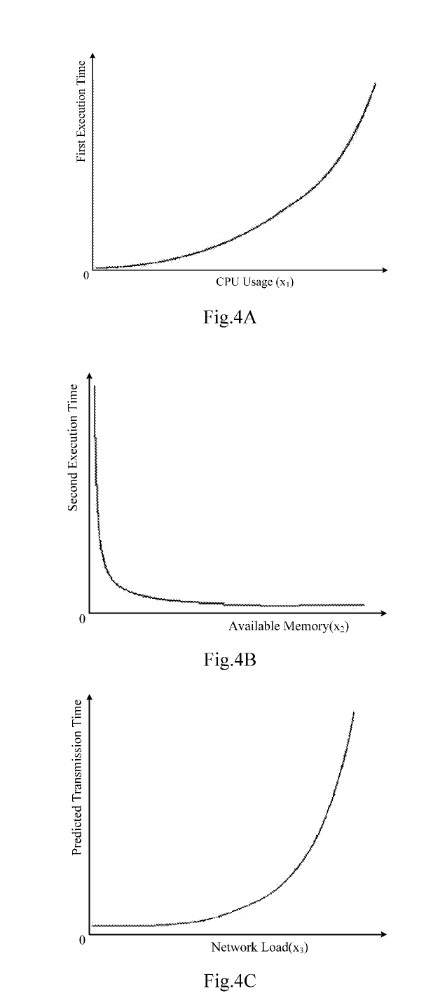

In the embodiment of the present invention, it is assumed that the first execution time t_{execution1} is an exponent function of the CPU usage, the function graph of which is shown in FIG. 4A. An expression of the exponent function is:

t_{execution1}(x₁)=φ₁e^{(k}^{₁}^{x}^{₁}^{^{λ1}}⁾+c₁ (2)

in which x₁ represents the CPU usage, and φ₁, k₁, λ₁, c₁ are constants larger than 0.

It is assumed that the second execution time t_{execution2} is an exponent function on the available memory, the function graph of which is shown in FIG. 4B. An expression of the exponent function is:

t_{execution2}(x₂)=φ₂e^{(k}^{₂}^{x}^{₂}^{^{λ2}}⁾+c₂ (3)

in which x₂ represents the available memory, φ₂, k₂, c₂ are constants larger than 0, and φ₂ is a constant smaller than 0.

Therefore, the predicted execution time PET of the current command is:

PET=t_{execution1}(x₁)+t_{execution2}(x₂)=φ₁e^{(k}^{₁}^{x}^{₁}^{^{λ1}}⁾+c₂+φ₂e^{(k}^{₂}^{x}^{₂}^{^{λ2}}⁾+c₂ (4)

The parameters φ₁, k₁, λ₁, c₁, φ₂, k₂, λ₂, c₂ in the above expressions (2) and (3) may be determined according to history data obtained by executing commands prior to the current command. Particularly, each time a command is executed, the history data concerning the command being executing on the remote machine are recorded. The history data include actual execution time of the command on the remote machine, and a CPU usage and an available memory of the remote machine when executing the command, and the history data are stored in a command execution history data table as shown in Table 2. Then, each time the predicted execution time of a command is computed, the latest parameters φ₁, k₁, λ₁, c₁, φ₂, k₂, λ₂, c₂ are computed first according to the history data of commands executed before the command, which are stored in the execution history data table. These parameters may be determined according to the history data by using methods commonly known in the art. For example, the parameters φ₁, k₁, λ₁, c₁, φ₂, k₂, λ₂, c₂ (fitted values) may be computed using a regression analysis method by substituting the history data obtained through execution of previous commands into the above expression (4). Since the method for determining the parameters is commonly known in the art, the detail description thereof is omitted here.

TABLE 2
Command Execution History Data Table

| | Actual execution | CPU usage | Available memory |
|---|---|---|---|
| Index | time (ms) | (%) | (kByte) |
| 1 | 20 | 50% | 2095536 |
| 2 | 45 | 65% | 2095536 |
| 3 | 35 | 50% | 1595536 |
| 4 | 29 | 50% | 2095536 |
| 5 | 18 | 65% | 2795536 |
| 6 | 8 | 20% | 2095536 |
| . . . | . . . | . . . | . . . |

When the predicted execution time PET of the current command is computed at step S2052, firstly, the latest parameters φ₁, k₁, λ₁, c₁, φ₂, k₂, λ₂, c₂ are computed by using the history data obtained by execution of previous commands and are used to replace (i.e. update) original parameters, so as to obtain the latest expression (4); then the current CPU usage (x₁) and the current available memory (x₂) of the remote machine are acquired and are substituted into the latest expression (4) to thereby compute the predicted execution time PET of the current command.

(2) Predicted Transmission Time PTT

The predicted transmission time PTT of the current command is highly associated with a network load at the time when the command is sent to the remote machine. The network load refers to a load of a path between the command controller and the remote machine, and is represented by a data rate on the path. In the embodiment of the present invention, it is assumed that the predicted transmission time PTT is an exponent function on the network load, the function graph of which is shown in FIG. 4C. An expression of the exponent function is:

PTT(x₃)=φ₃e^{(k}^{₃}^{x}^{₃}^{^{λ3}}⁾+c₃ (5)

in which x₃ represents the network load at the time when the command is sent to the remote machine, and φ₃, k₃, λ₃, c₃ are constants larger than 0.

The parameters φ₃, k₃, λ₃, c₃ in the above expression (5) are also determined according to history data. Particularly, each time when a command is sent to the remote machine, the history data concerning sending the command are recorded, which include actual transmission time of the command (i.e. actual transmission time from the time when the command is sent to the time when the command arrives at the remote machine) and a network load at this time, then these history data are recorded in a command transmission history data table shown in the following Table 3. Subsequently, each time the predicted transmission time PTT of a command is computed, the latest parameters are computed first according to the transmission history data of previous commands, which are stored in the command transmission history data table. Likewise, the parameters (fitted values) may be determined by using methods commonly known in the art, such as the regression analysis method.

TABLE 3
Command Transmission History Data Table

| | Actual transmission | Network load |
|---|---|---|
| Index | time (ms) | (kbps) |
| 1 | 5 | 1024 |
| 2 | 12 | 4096 |
| 3 | 3 | 512 |
| 4 | 8 | 2048 |
| . . . | . . . | . . . |

When the predicted transmission time PTT of the current command is computed at step S2052, firstly, the latest parameters φ₃, k₃, λ₃, c₃ are computed by using the transmission history data of previous commands and used to replace (i.e. update) original parameters, so as to obtain the latest expression (5); then the current network load is obtained and substituted into the latest expression (5) to thereby compute the predicted transmission time PTT of the current command.

(3) Execution Result Live Time LT

The execution result live time LT of the current command may be computed by the following expression:

LT=ET−CT (6)

in which ET is an expire time of the execution result of the current command (or an expire time of an execution result of a same command executed previously), which may be specified by the management platform or automatically determined by the command controller according to natures of the command (for example, a use of the command). CT is a current time.

(4) Command Frequency CF

The command frequency CF of the current command (which is in the unit of, for example, times/second) may be computed by counting a number of times that the current comment (in other words, a command the same as the current command) is received in unit time.

After the above properties are computed, these properties are stored in a corresponding entry of the command register table as shown in Table 1.

Referring to FIG. 3 again, after the computation at step S2052 is finished, the priority of the command is computed according to the computed predetermined properties at step S2053.

Specifically, earliest finish time EFT of the current command is computed firstly; for a command that has not been launched (i.e. has not been sent to the remote machine), the earliest finish time EFT is time needed for obtaining an execution result of the command even if the command is immediately launched to be sent to the remote machine and executed on the remote machine. Since the command has to experience two processes of transmission and execution after being sent, the time is a sum of the predicted transmission time and the predicted execution time of the command as shown in the following expression (7):

EFT=PET+PTT (7).

Then, latest launch time LLT of the current command is computed according to the following expression (8); the latest launch time LLT is latest time at which the current command is launched so that the execution result of the current command is returned before an old execution result obtained by executing a previous same command expires.

LLT=LT−EFT (8)

For example, if the old execution result will expire after 10 seconds, that is, LT=10 s, and the earliest finish time EFT of the current command is 6 seconds, the latest launch time of the current command is LLT=10−6=4 s. At this time, if the current command is launched in 4 seconds, the execution result of the current command can be returned before the old execution result expires so as to update the old execution result.

That is to say, when LLT>0, the temporarily stored old execution result will be updated before expiring if the current command is launched in time. When LLT<0, the temporarily stored old execution result will expire before the new execution result is returned to the command controller even if the current command is launched immediately, in which case there is an execution result expiring window which begins at the time when the old execution result expires and ends at the time when the new execution result is sent back to the command controller. Obviously, if a command is received during a time period indicated by the window, a corresponding execution result temporarily stored in the command controller will definitely expire before a new execution result is returned, thus the command needs to be re-executed. It can be seen that the execution result expiring window exists only when LLT<0 and a size of the window is −LLT.

After LLT is computed, a predicated time that has to be waited to execute the current command and return the new execution result due to absence of the execution result of the current command, i.e. predicated waiting time due to catch miss (PWTCM), is computed according to the following expression (9).

$$PWTCM = \{ \begin{matrix}0 & if LLT \geq 0 \\ CF \times {LLT}^{2} / 2 & if LLT < 0\end{matrix} \qquad ( 9 )$$

It can be seen from the expression (9) that the execution result expiring window will not appear and the waiting time PWTCM will be zero if LLT>=0. When LLT<0, the waiting time PWTCM is in direct proportion to a square of LLT and to the command frequency; that is, the larger the execution result expiring window is, the longer the waiting time PWTCM is, and the higher the command frequency is, the longer the waiting time PWTCM is.

Finally, the priority P of the current command is computed according to the following expression (10):

$$P = \{ \begin{matrix}- LLT & if LLT > 0 \\ PWTCM & if LLT \leq 0\end{matrix} \qquad ( 10 )$$

The priority P is used to determine the packaging order and the executing order of the command waiting to be executed in the command register table, in which the larger the priority P is, the earlier the command is packaged and executed. It can be known from the expression (10) that the execution result expiring window will not appear when LLT<0, and at this time, the priority P is negative, that is, the priority is low. When LLT>0, the execution result expiring window has appeared, and will be further extended, which prolongs PWTCM, if a corresponding command is not launched immediately, therefore, the priority P in this case is positive, that is, the priority is high.

By now, the process for determining the priority of the command in step S205 shown in FIG. 2 is terminated.

It is to be appreciated that although the predicted execution time, the predicted transmission time, the execution result expire time and the command frequency are used as the predetermined properties of the command to compute the priority of the command, this is not limitative. One or more of the four properties, or a combination of one or more of the four properties with other properties may be used as the predetermined properties of the command to compute the priority of the command, and the other properties may be, for example, a type of the executor of the command (remote physical machine or remote virtual machine), correlation between the command and other commands, and the like. For example, in the case where the command frequency CF is used to determine priorities of commands, a command having a high frequency can be made to have a high priority. In the case where the predicted execution time and the execution result live time are used to determine priorities of commands, the priorities can be computed by setting PTT in the above respective expressions to 0. The above and other variations are also applicable to embodiments described below.

The method for determining the command package maximum total execution time according to the current workload of the remote machine in step S207 shown in FIG. 2 will be described below.

Firstly, the current workload of the remote machine is detected. In the embodiment of the present invention, the workload of the remote machine is represented by a usage of resources of the remote machine. The usage of resources can be derived from the CPU usage and the available memory of the remote machine according to a predetermined rule, so that the workload of the remote machine can be derived.

Then, the maximum total execution time TET of command package is determined based on the current workload of the remote machine and according to predefined relationship between the workload of the remote machine and the command package maximum total execution time. The command package maximum total execution time refers to a maximum value of a sum of predicted execution time of commands in the command package. The relationship may be defined experientially or according to actual requirements; for example, it can be defined that the command package maximum total execution time is 100 ms when the workload of the remote machine is 30%. However, preferably the relationship between the maximum total execution time TET of command package and the workload of the remote machine is defined as satisfying an exponent function relationship, the function graph of which is shown in FIG. 5 and the expression of which is:

TET(x₄)=φ₄e^{(k}^{₄}^{x}^{₄}^{^{λ4}}⁾+c₄ (11)

in which x4 represents the workload of the remote machine, φ₄, k₄, c₄ are constants larger than 0, and λ₄ is a constant smaller than 0. Likewise, φ₄, k₄, λ₄, c₄ may be determined according to history data. For example, a history data table for command package can be established. Firstly, initial values of φ₄, k₄, λ₄, c₄ are set experientially; then each time when execution of commands in a command package is finished, the workload of the remote machine at the time of execution of the command package and actual total execution time of the commands in the command package are recorded in the history data table for command package as the history data; and subsequently, latest values of the parameters φ₄, k₄, λ₄, c₄ are determined according to these history data by using a regression analysis method or other methods commonly known in the art. Preferably, each time when the command package maximum total execution time is computed, the parameters φ₄, k₄, λ₄, c₄ are computed and updated firstly by using the history data (the actual total execution time and the workload of the remote machine) of command packages prior to the current command package, so as to compute the command package maximum total execution time by using the latest expression (11). Certainly, the relationship between the maximum total execution time and the workload of the remote machine can be defined by using other functions, besides the above exponent function relationship.

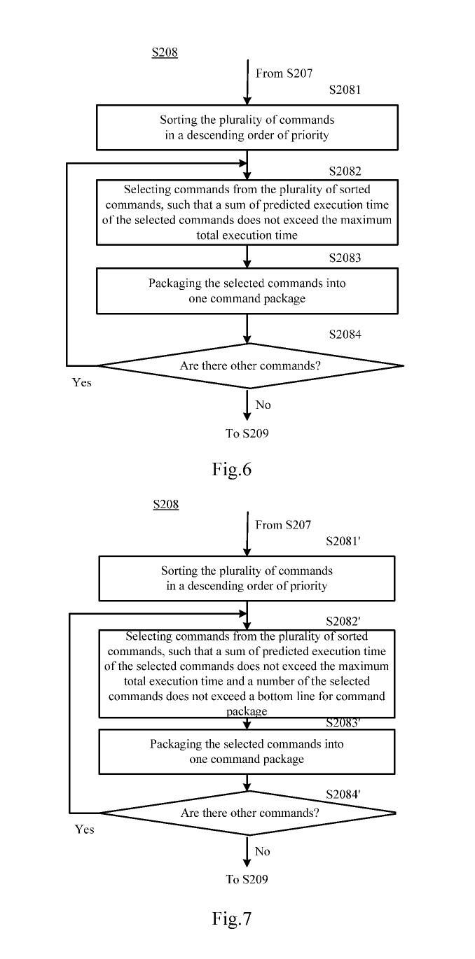

The process for packaging the commands in step S208 shown in FIG. 2 will be described below with reference to FIG. 6.

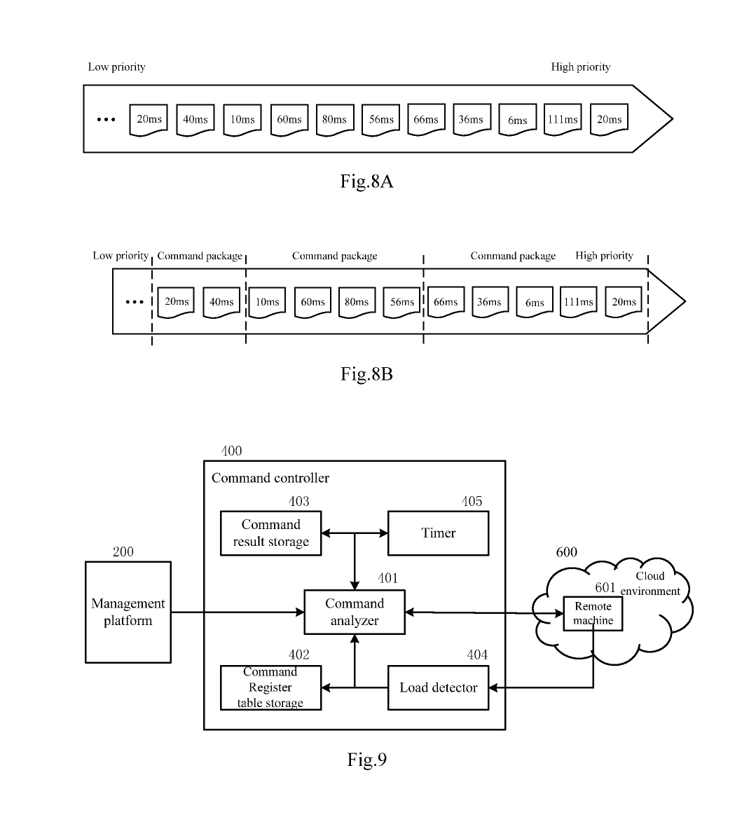

First, at step S2081, the plurality of commands are sorted in an order from a highest one to a lowest one of the priorities of the plurality of commands determined in step S205, i.e. in a descending order of priority. FIG. 8A schematically shows an example of commands sorted in a descending order of priority.

Next, at step S2082, commands are selected from the plurality of sorted commands so that a sum of the predicted execution time of the selected commands does not exceed the maximum total execution time, and then the selected commands are packaged into one command package at step S2083.

Next, at step S2084, it is checked whether there are other commands which have not been packaged. If there are other commands which have not been packaged exist, the process returns to step S2082. On the contrary, if there are no other commands, that is, if all commands have been packaged into command packages, the process proceeds to step S209.

In the above process of packaging, a number of commands in a command package is determined according to only the command package maximum total execution time. In this case, if the workload of the remote machine is low, it can be known from FIG. 5 that the computed maximum total execution time is large, which indicates that the generated command package includes a great number of commands. The remote machine receiving the command package has to execute the great number of commands in a short time, indicating that a response speed of the remote machine to other commands is slow, which degrades the performance of the cloud environment.

In order to solve the above problem, in a variant of the embodiment of the present invention, a command package bottom line is preset, besides predefining the relationship between the command package maximum total execution time and the workload of the remote machine as described above. The command package bottom line refers to a maximum number of commands that are allowed to be included in a command package in any case. That is, the number of the commands in the command package may not exceed the command package bottom line, even if the current workload of the remote machine is 0. The command package bottom line may be set experientially or according to any appropriate principle. However, it is preferable to set the command package bottom line according to a golden section principle. Specifically, the command package bottom line is set, so that when commands which are included in a command package and a number of which is equal to the command package bottom line are execute by the remote machine, the workload of the remote machine is 0.68 times of a maximum workload of the remote machine at the time when it can work normally.

FIG. 7 shows a flow chart of step S208 in the variant. Step S2081′, S2083′, and S2084′ shown in FIG. 7 are the same as steps S2081, S2083, and S2084 shown in FIG. 6, respectively, the description of which is omitted herein for the sake of simplicity. In step S2082′ shown in FIG. 7, commands are selected from the plurality of sorted commands, such that a sum of predicted execution time of the selected commands does not exceed the maximum total execution time and a number of the selected commands does not exceed the command package bottom line. FIG. 8B schematically shows a result of packaging the commands shown in FIG. 8A.

In the above process of packaging, the workload of the remote machine is detected once only when the packaging begins, and then all of the commands are packaged based on the command package maximum total execution time computed according to the workload. However, since it takes time to perform the packaging, the workload of the remote machine may vary a considerable amount during this period of time. In view of this, besides the steps shown in FIG. 2, an instantaneous workload of the remote machine may be detected during the process of packaging, and if a variation amount of the instantaneous workload relative to a workload detected when the packaging begins exceeds a predetermined threshold, the instantaneous workload is used to determine newly a maximum total execution time of subsequent command packages, and the newly determined maximum total execution time is used for a subsequent packaging process.

As described above, the command packages are sent to the remote machine. After executing the commands in the command packages, the remote machine sends execution results back to the command controller, and the command controller temporarily stores the execution results therein. Then, the execution results are sent to the management platform.

A command controller according an embodiment of the present invention will be described below. FIG. 9 shows a block diagram of the command controller.

As shown in FIG. 9, the command controller 400 according to the embodiment of the present invention is connected between a management platform 200 and a cloud environment 600. The management platform 200 is an entity for building and updating the cloud environment, and sends a plurality of commands which need to be executed in the cloud environment 600 to the command controller 400. It is to be appreciated that, although the command controller 400 is shown here as being independent of the management platform 200, the command controller 400 may also be a part of the management platform 200 and schedule the commands which need to be executed in the cloud environment 600 sent from the management platform 200.

The cloud environment 600 consists of many remote machines (or remote servers). For the sake of clarity, only one remote machine 601 is shown in FIG. 8, which receives and executes a command sent from the command controller 400, and sends an execution result back to the command controller 400. Since the respective remote machines in the cloud environment 600 execute substantially the same operations, the description is made below by using the remote machine 601 as an example.

The command controller 400 includes a command analyzer 401, a command register table storage 402, a command result storage 403, a load detector 404 and a timer 405.

The command analyzer 401 determines a priority of each of the plurality of commands according to predetermined properties of the command, determines command package maximum total execution time according to a current workload of the remote machine 601 detected by the load detector 404 (described later), packages the plurality of commands into one or more command packages in a descending order of priority according to the maximum total execution time, and sends the one or more command packages to the remote machine 601.

In an exemplary implementation of the command controller according to the embodiment of the present invention, in order to satisfy requirements of different commands for real-time execution well, the command analyzer 401 receives the plurality of commands sent from the management platform 200, analyzes the commands to determine whether the commands are to be executed in real time, sends the commands directly to the cloud environment (the remote machine 601) for execution when the commands are to be executed in real time, and performs operations described below on the commands when the commands are not to be executed in real time. These operations will be described in detail later.

The command register table storage 402 is, for example, a cache which stores the command register table shown in Table 1. Information related to commands which are not be executed in real time and execution results of which do not exist are stored in the command register table. Since the command register table has been described above, it is not described repeatedly.

The command result storage 403 is, for example, a cache which stores the execution results obtained by executing the commands by the remote machine 601. As described above, when the remote machine 601 has executed a command sent from the command analyzer 401, it sends an execution result of the command back to the command analyzer 401; then, the command analyzer 401 stores the execution result into the command result storage 403, and modifies a result pointer corresponding to the command in the command register table so as to make it indicate a storage position of the execution result in the command result storage 403.

The load detector 404 is used to detect a load of a network at the time when the command is sent to the remote machine 601 via the network. In addition, the load detector 404 also detects a CPU usage and an available memory of the remote machine 601 when it executes the command, so as to detect a workload of the remote machine 601. Preferably, when the process of packaging begins, the load detector 404 continuously detects an instantaneous workload of the remote machine 601, and sends an indication signal to the command analyzer 401 when a variation amount of the instantaneous workload relative to a workload detected when the packaging begins exceeds a predetermined threshold.

The timer 405 is used for timing so as to provide current time CT to the command analyzer 401. The command analyzer 401 computes an execution result live time LT of the command by using the current time CT.

The operations of the command controller 400 will be described in detail below.

When the command controller 400 is started, the command analyzer 401 checks whether a command to be executed on the remote machine 601 is received from the management platform 200, and determines whether the command is to be executed in real time when the command is received. The method by which the command analyzer 401 determines whether the command is to be executed in real time is same as that described above, and is not described here repeatedly. Likewise, if the command controller 400 is a part of the management platform 200, the command analyzer 401 may not perform the checking operation.

If the command is to be executed in real time, the command analyzer 401 sends the command directly to the remote machine 601. The remote machine 601 executes the command and sends an execution result back to the command analyzer 401. Then, the command analyzer 401 sends the execution result back to the management platform 200.

On the contrary, if the command is not to be executed in real time, the command analyzer 401 further determines whether an execution result of the command has already been in the command result storage 403. If the answer is “YES”, the command analyzer 401 reads out the execution result from the command result storage 403, and sends it to the management platform 200 without executing the command once more.

On the other hand, if the execution result of the command does not exist, the command analyzer 401 determines a priority of the command according to predetermined properties of the command. The command analyzer 401 may determine the priority of the command in a manner described below.

Firstly, the command analyzer 401 stores the command in a command register table, that is, establishes an entry for the command in the command register table and stores information related to the command is stored in the entry.

Then, the command analyzer 401 computes the predetermined properties of the command, which include predicted execution time, predicted transmission time, execution result live time, and a command frequency as described above.

Specifically, the command analyzer 401 computes the predicted execution time of the command according to the above expressions (1)-(4) by using the current CPU usage and the current available memory of the remote machine 601 detected by the load detector 404. As described above, it is preferable to, before the predicted execution time of the command is computed, compute latest parameters φ₁, k₁, λ₁, c₁, φ₂, k₂, λ₂, c₂ according to history data of commands executed before the command which are stored in, for example, the command execution history data table as shown in Table 2. Then, the predicted execution time is computed by using the updated expression (4), and the current CPU usage and the current available memory. Moreover, the command analyzer 401 computes the predicted transmission time of the current command according to the above expression (5) by using the current network load detected by the load detector 404. Likewise, it is preferable to, before the predicted transmission time is computed, compute latest parameters φ₃, k₃, λ₃, c₃ according to transmission history data of commands prior to the command which are stored in, for example, the command transmission history data table as shown in Table 3. Then, the predicted transmission time is computed by using the updated expression (5) and the current network load. The methods for determining the parameters φ₁, k₁, λ₁, c₁, φ₂, k₂, λ₂, c₂ are the same as those described above, and are not described here repeatedly. In addition, the command analyzer 401 computes the execution result live time of the command according to the above expression (6) by using an expire time of the command and the current time provided by the timer 405, and computes the command frequency of the command according to a counted number of times by which the command is received in unit time.

After the above properties of the command are determined, the command analyzer 401 stores these properties into a corresponding entry in the command register table.

Subsequently, the command analyzer 401 computes the priority of the command according to the computed predetermined properties. As described above, the command analyzer 401 computes earliest finish time EFT, latest launch time LLT and predicted waiting time PWTCM of the command by using respectively the expressions (7)-(9) according to the properties, and then computes the priority of the command by using the expression (10). Of course, as described above, the command analyzer can also compute the priority of the current command by using one or more of the predicted execution time, the predicted transmission time, the execution result live time and the command frequency thereof or other properties.

The command analyzer 401 performs the above operations on each of the plurality of commands received from the management platform, so as to determine priorities of the respective commands.

Then, the command controller 401 determines command package maximum total execution time according to a detected current workload of the remote machine.

Specifically, the load detector 404 detects the current workload of the remote machine 601, and provides the current workload to the command analyzer 401. The command analyzer 401 computes the command package maximum total execution time according to the current workload of the remote machine through the relationship between the command package maximum total execution time and the workload of the remote machine as described above. It is be noted that if the relationship between the command package maximum total execution time and the workload of the remote machine is defined by a function, it is preferable to update the function according to history data (the actual total execution time and the workload of the remote machine) of command packages executed before the current command package each time before the command package maximum total execution time is computed, so as to compute the maximum total execution time by using the latest function, thereby improving accuracy.

Next, the command analyzer 401 packages the plurality of commands into the one or more command packages respectively in a descending order of priority according to the maximum total execution time.

Specifically, the command analyzer 401 sorts the respective commands in the descending order of the priorities thereof. Then, commands are selected from the plurality of sorted commands such that a sum of predicted execution time of the selected commands does not exceed the computed maximum total execution time, and the selected commands are packaged into one command package. Next, for other commands to be packaged in the command register table, the command analyzer 401 repeats the above operations of selecting and packaging commands, until all of the commands in the command register table are packaged into commands packages.

In order to avoid the problem of a command package including too many commands due to a low workload of the remote machine, preferably a command package bottom line is preset, besides predefining the relationship between the command package maximum total execution time and the workload of the remote machine. In this case, after the plurality of commands are sorted in a descending order of priority, the command analyzer 401 selects commands from the plurality of sorted commands such that a sum of predicted execution time of the selected commands does not exceed the computed maximum total execution time and a number of the selected commands does not exceed the preset command package bottom line, and then packages the selected commands into one command package. Subsequently, for other commands, the command analyzer 401 repeats the above selecting and packaging operations, until these commands are packaged into commands packages.

In addition, preferably, during the process of packaging, if an indication signal indicating that a variation amount of an instantaneous workload of the remote machine 601 relative to a workload detected when the packaging begins exceeds a predetermined threshold is received from the load detector 404, the command analyzer 401 newly determines the command package maximum total execution time by using the instantaneous workload, and uses the maximum total execution time for a subsequent packaging process.

After the packaging of the commands is finished, the command analyzer 401 sends the generated one or more command packages to the remote machine 601. The remote machine 601 executes the commands in the command packages, and sends execution results back to the command analyzer 401. The command analyzer 401 stores the execution results in the command result storage 403, and updates result pointers corresponding to the commands in the command register table.

It can be seen that in the command controlling method and the command controller according to the embodiment of the present invention, by classifying commands into two types, the number of commands executed in real time is reduced, and the risk of failure of a task due to malfunction of a network connection with the remote machine is lowered. In addition, priorities of commands are determined according to properties of the commands, and the commands are packaged according to the priorities of the commands and the workload of the remote machine executing the commands. Thus, a number of commands provided to the remote machine each time may be controlled adaptively according to the workload of the remote machine, and effective scheduling of the commands may be achieved, such that execution of the commands and invoking of the fundamental command line interface are more orderly, thereby reducing the risk of failed command execution and improving the performance of the cloud environment.

It is to be recognized that the embodiments described above are only illustrative, not limitative. For example, as mentioned above, for a command which is not to be executed in real time, it is checked whether an execution result thereof has existed, and if the execution result thereof has existed, the execution result is sent directly to the management platform without executing the command once more. This can decrease the number of executed commands and reduce the workload of the cloud environment. However, in order to reduce the workload of the command analyzer 401, this checking may be not performed, and instead, all commands which are not to be executed in real time are subjected to the packaging processing, and then are sent to the remote machine 601 for execution.

Although the exemplary embodiments of the present invention have been shown and described, it is to be understood by those skilled in the art that various changes in form and details can be made thereto without departing from the scope and spirit of the present invention as defined in the following claims and equivalents thereof.

We claim:

1. A command controlling method for controlling execution of a plurality of commands on a remote machine, comprising:
determining a priority of each of the plurality of commands according to predetermined properties of the command;
determining command package maximum total execution time according to a current workload of the remote machine;
packaging the plurality of commands into one or more command packages in a descending order of priority according to the maximum total execution time, respectively; and
sending the one or more command packages to the remote machine.

2. The command controlling method according to claim 1, further comprising:
computing the predetermined properties of each of the plurality of commands,
wherein the predetermined properties include at least one of predicted execution time, predicted transmission time, execution result live time, and a command frequency of the command.

3. The command controlling method according to claim 2, wherein the predicted execution time satisfies an exponent function relationship with a CPU usage and an available memory of the remote machine, respectively.

4. The command controlling method according to claim 2, wherein the predicted transmission time satisfies an exponent function relationship with a network load at the time when the command is sent to the remote machine.

5. The command controlling method according to claim 2, wherein parameters of an exponent function are determined according to history data of commands prior to the command.

6. The command controlling method according to claim 5, wherein the parameters of the exponent function are updated according to the history data of the commands prior to the command, before the predetermined properties of the command are computed.

7. The command controlling method according to claim 1, wherein the command package maximum total execution time is determined based on the current workload of the remote machine and according to a predefined relationship between the workload of the remote machine and the command package maximum total execution time.

8. The command controlling method according to claim 2, wherein the step of packaging the plurality of commands into one or more command packages in a descending order of priority comprises:
sorting the plurality of commands in the descending order of priority;
selecting commands from the plurality of sorted commands, such that a sum of predicted execution time of the selected commands does not exceed the maximum total execution time;
packaging the selected commands into one command package; and
repeating the above selecting and packaging steps, until the plurality of commands are packaged into the one or more command packages, respectively.

9. The command controlling method according to claim 2, wherein the step of packaging the plurality of commands into one or more command packages in a descending order of priority comprises:
sorting the plurality of commands in the descending order of priority;
selecting commands from the plurality of sorted commands, such that a sum of predicted execution time of the selected commands does not exceed the maximum total execution time and a number of the selected commands does not exceed a preset command package bottom line, the command package bottom line being a maximum number of commands that are allowed to be included in a command package;
packaging the selected commands into one command package; and
repeating the above selecting and packaging steps, until the plurality of commands are packaged into the one or more command packages, respectively.

10. The command controlling method according to claim 9, wherein the command package bottom line is set according to a golden section principle.

11. The command controlling method according to claim 1, further comprising:
detecting an instantaneous workload of the remote machine, wherein if a variation amount of the instantaneous workload relative to the current workload exceeds a predetermined threshold, the instantaneous workload is used to newly determine the command package maximum total execution time.

12. A command controller for controlling execution of a plurality of commands on a remote machine, comprising:
a load detector for detecting a current workload of the remote machine; and
a command analyzer for determining a priority of each of the plurality of commands according to predetermined properties of the command, determining command package maximum total execution time according to the detected current workload of the remote machine, packaging the plurality of commands into one or more command packages in a descending order of priority according to the maximum total execution time, and sending the one or more command packages to the remote machine.

13. The command controller according to claim 12, wherein the command analyzer further computes the predetermined properties of the each of the plurality of commands, the predetermined properties including at least one of predicted execution time, predicted transmission time, execution result live time, and a command frequency of the command.

14. The command controller according to claim 13, wherein the predicted execution time satisfies an exponent function relationship with a CPU usage and an available memory of the remote machine, respectively.

15. The command controller according to claim 13, wherein the predicted transmission time satisfies an exponent function relationship with a network load at the time when the command is sent to the remote machine.

16. The command controller according to claim 13, wherein the command analyzer determines parameters of an exponent function according to history data of commands prior to the command.

17. The command controller according to claim 16, wherein before computing the predetermined properties of the command, the command analyzer updates the parameters of the exponent function according to the history data of the commands prior to the command.

18. The command controller according to claim 12, wherein the command analyzer determines the command package maximum total execution time based on the current workload of the remote machine and according to predefined relationship between the workload of the remote machine and the command package maximum total execution time.

19. The command controller according to claim 13, wherein the command analyzer packages the plurality of commands into the one or more command packages in the descending order of priority in a manner of:
sorting the plurality of commands in the descending order of priority;
selecting commands from the plurality of sorted commands, such that a sum of predicted execution time of the selected commands does not exceed the maximum total execution time;
packaging the selected commands into one command package; and
repeating the above selecting and packaging steps, until the plurality of commands are packaged into the one or more command packages, respectively.

20. The command controller according to claim 13, wherein the command analyzer packages the plurality of commands into the one or more command packages in the descending order of priority in a manner of:
sorting the plurality of commands in the descending order of priority;
selecting commands from the plurality of sorted commands, such that a sum of predicted execution time of the selected commands does not exceed the maximum total execution time and a number of the selected commands does not exceed a preset command package bottom line, the command package bottom line being a maximum number of commands that are allowed to be included in a command package;
packaging the selected commands into one command package; and
repeating the above selecting and packaging steps, until the plurality of commands are packaged into the one or more command packages, respectively.

21. The command controller according to claim 20, wherein the command package bottom line is set according to a golden section principle.

22. The command controller according to claim 12, wherein the load detector further detects an instantaneous workload of the remote machine, and wherein if a variation amount of the instantaneous workload relative to the current workload exceeds a predetermined threshold, the instantaneous workload is used to newly determine the command package maximum total execution time.
